(19) United States
(12) Patent Application Publication
(10) Pub. No.: US 2011/0016137 A1
(43) Pub. Date: Jan. 20, 2011

(54) System For Determining Virtual Proximity Of Persons In A Defined Space

(76) Inventors: Dmitry Goroshevsky, Valbonne (FR); Andrew Stoudnev, Vallauris (FR); Julius Goriavsky, Antibes (FR)

Correspondence Address: CENTRAL COAST PATENT AGENCY, INC, 3 HANGAR WAY SUITE D, WATSONVILLE, CA, 95076, US

(21) Appl. No.: 11/853,771

(22) Filed: Sep. 11, 2007

Related U.S. Application Data
(60) Provisional application No. 60/843,823, filed on Sep. 11, 2006.

(51) Int. Cl. G06F 17/30

(52) U.S. Cl. 707/758; 707/E17.005

(57) ABSTRACT

A system for comparing preferences of persons has a first mechanism gathering preferences of persons, a second mechanism for rendering each preference as a numerical value, a third mechanism for plotting each numerical value representing a preference for a person in a separate dimension of multi-dimensional space, providing for each person a point in the multi-dimensional space, and a fourth mechanism for determining distance in multidimensional space between any two points representing different persons, and for storing the distances calculated in a data repository.

### CROSS-REFERENCE TO RELATED APPLICATIONS

The present invention claims priority to a U.S. provisional patent application Ser. No. 60/843,823, entitled “User proximity search system, method and API” and filed on Sep. 11, 2006, disclosure of which is included herein at least by reference.

### BACKGROUND OF THE INVENTION

1. Field of the Invention

The present invention is in the field of network interaction behavior analysis and result calculation, and pertains particularly to methods and apparatus for plotting personal preference and/or performance results in a virtual space and calculating distance (quantitative separation) between persons or their personal representations in the space, and between other points in the space.

2. Discussion of the State of the Art

In the field of network interaction behavioral analysis, various methods are employed to track and to analyze personal behavior online for the purposes of improving services to those persons, directing advertisements to those persons, and matching services or products to those persons among other enterprise objectives. The art of attempting to predict what a person is looking for in a product, service, or looking for relative to another person is an art that is continually being developed and extended.

One method for determining preferences of a user is to glean information from a user profile that the user has created relative to some interactive service. Another method is to poll a user with a series of questions presented in an electronic form or survey. Another technique is to view the user's navigation behavior, search history, or purchasing history, and to use this information to create a user profile. In some of the above-mentioned methods values may be derived and assigned to certain aspects of user behavior or stated preferences. That is, it is common to represent such information quantitatively. A very simple example is the situation wherein a person may be asked to grade a response to a question by indicating a number between 1 and 10, or between one and a hundred, for example.

More recently, social interaction network services have been provided that use profile data submitted by persons, including personal preferences, to ascertain likeness of a person to other persons or to predict a possible preference for certain services or products.

User surveys and questionnaire practices designed to glean useful information about persons for advertising purposes are often less accurate because persons tend to know what the surveys are for and may purposely mislead while answering such solicitations. Such systems are typically designed with advertising in mind, which can be an annoyance to persons constantly barraged with questions. Other predictive systems are very complex using algorithms and weighting systems and are not practical in many cases.

According to wikipedia.org a social network is a structure comprising nodes representing, typically, persons or organizations, that are related by one or more specific characteristics, such as values, visions, ideas, financial exchanges, common friends, kinship, dislike, conflict, trade, web links, sexual preferences, disease transmission (epidemiology), airline routes, and any of many other criteria and characteristics.

Social network analysis typically views social relationships in terms of nodes and ties. Nodes are the individual entities within the networks, and ties are the relationships between the entities. There can be many kinds of ties between nodes in a social network. Research in a number of academic fields has shown that social networks operate on many levels, from individuals, to families, up to the level of nations, and such networks and knowledge about them play a critical role in determining the way problems might be solved, organizations may be managed, and the degree to which individuals might succeed in achieving their personal goals. In a simple form a social network may be a map of relevant ties between the nodes being studied. Such a network can also be used to determine the social capital of individual entities. These concepts are often displayed in a social network diagram, where nodes are points and ties are lines between the points.

In the present electronic age we have witnessed advent of many on-line social networks, such as MySpace.com, freindsters.com, facebook.com, livejournal.com, and so on. Most social network services are primarily web-based and provide a collection of various ways for persons to interact, such as chat, messaging, email, video, voice chat, file sharing, blogging, discussion groups, and so on.

On-line social networks are formed between people who find each other typically by using search-criteria such as age, gender, points of interests and so on. Clearly such systems for finding other people to be included in one's own social network is time consuming and often less than effective. One usually needs to study the other's opinions, such as, for example, visiting the other's personal web page and reading personal views in order to determinate if a person should be included in one's own social network.

In social network analysis one of the main Metrics (Measures) is Closeness, which may be defined as the degree an individual is near other individuals in a network, directly or indirectly. Closeness reflects an ability to access information through the “grapevine” of network members. Thus, closeness is the inverse of the sum of the shortest distances between each individual and every other person in the network.

What is clearly needed is a system and methods for representing characteristics of persons quantitatively, in a manner that the results may be plotted in multidimensional space, and a mechanism for determining distance in that space between the plotted points representing the characteristic of persons.

### SUMMARY OF THE INVENTION

In one embodiment of the present invention a method for comparing preferences of persons is provided, comprising the steps of (a) determining a plurality of preferential characteristics of a first person, quantifying each of the plurality of characteristics of the first person, and expressing each quantified characteristic in a separate dimension of a multi-dimensional space having a number of dimensions equal to the number of characteristics to be represented, providing thereby a first point in the multidimensional space; (b) determining a plurality preferential characteristics of a second person, quantifying each of the plurality of characteristics of the second person, and expressing each quantified characteristic in a separate dimension of a multi-dimensional space having a number of dimensions equal to the number of characteristics, providing thereby a second point in the multidimensional space; and (c) calculating distance in the multidimensional space between the first and the second point, thereby providing an indication of the nearness of preference between the two persons.

In one embodiment determining in steps (a) and (b) is accomplished by soliciting from persons answers to questions. Also in one embodiment, in steps (a) and (b) quantifying is accomplished by framing questions to elicit quantitative responses. In one embodiment the space is Cartesian, the dimensions are separate axes all originating from a common point, and each of the plurality of characteristics is rendered as a numerical value plotted on the appropriate axis.

In another aspect of the invention a system for comparing preferences of persons is provided, comprising a first mechanism gathering preferences of persons, a second mechanism for rendering each preference as a numerical value, a third mechanism for plotting each numerical value representing a preference for a person in a separate dimension of multi-dimensional space, providing for each person a point in the multi-dimensional space, and a fourth mechanism for determining distance in multidimensional space between any two points representing different persons, and for storing the distances calculated in a data repository.

In one embodiment of the method there is a fifth mechanism for interpreting the distance determined between two points as a difference in personal preference between the persons whose preferences are represented by the points. Also in one embodiment the first mechanism gathers by soliciting from persons answers to questions. In some embodiments in steps (a) and (b) quantifying is accomplished by framing questions to elicit quantitative responses. In some cases the multi-dimensional space is Cartesian, the dimensions are separate axes originating from a common point, and each of the plurality of characteristics is rendered as a numerical value plotted on the appropriate axis. In one embodiment there is a fifth mechanism allowing one person to retrieve distances from the data repository as information for guiding decisions.

In yet another aspect of the invention a method for predicting characteristics of persons is provided, comprising steps of (a) determining a plurality of preferential characteristics for each of a plurality of persons, quantifying each of the plurality of characteristics for each person, and expressing each quantified characteristic in a separate dimension of a multi-dimensional space having a number of dimensions equal to the number of characteristics to be represented, providing thereby a point in the multidimensional space representing characteristics of each person; and (b) calculating distance in the multidimensional space between individual ones of the points, and using the calculated distances to predict one or more characteristics for at least one person other than those characteristics plotted for that one person in the multi-dimensional space.

In one embodiment of this method where a first characteristic is known for one person other than characteristics plotted for that person in the multi-dimensional space, the first characteristic is then assumed for other persons whose points in the multi-dimensional space lie within a pre-selected distance from the point for the one person.

### BRIEF DESCRIPTION OF THE DRAWING FIGURES

FIG. 1 is a diagram illustrating a system in one embodiment of the present invention, and operation for determining person's preferences.

FIG. 2 is a diagram illustrating operation determining distance between two persons.

FIG. 3 is a diagram illustrating operation for determining nearest and farthest persons.

### DETAILED DESCRIPTION

The present invention in one embodiment is a system, method and system API for determining, in some cases automatically, proximity of users based on certain input parameters, one of which may be behavior. After determining a profile for a person, which may include behavior and/or preferences, the user's profile is represented as a point in multidimensional space. A proximity engine then may determine nearest or most distant points in this space, and also determines proximity of this user to other users whose profiles may be plotted in the same space.

Several US patent documents provide reference for the present invention:
U.S. Pat. No. 7,152,061
Curtis, et al. Dec. 19, 2006
“Methods and Systems for Providing a Response to a Query”
U.S. Pat. No. 7,177,880
Ruvolo, et al. Feb. 13, 2007
“Method of Creating and Displaying Relationship Chains Between Users of a Computerized Network”
U.S. Pat. No. 7,188,141
Novaes Mar. 6, 2007
“Method and System for Collaborative Web Research”

Each of these documents is incorporated in the present application at least by reference.

Another reference work important to this specification is “Foundations of Multidimensional and Metric Data Structures” (The Morgan Kaufmann Series in Computer Graphics) by Hanan Samet. This book in its latest edition is available from Amazon.com, and is incorporated herein in its entirety by reference.

The system of the invention in one embodiment comprises three principle parts: (1) a front-end, (2) a back-end incorporating a proximity engine, and (3) a data base. Using a front-end, which may be a web server in one embodiment, a person's personal data is determined. In some cases this may be provided by the person in an interactive manner, and in other cases may be determined from pre-existing or stored information, or by a combination of both. In an interactive embodiment a person answers questions, such as by choosing a right answer from a list of answers, for example in a pre-defined web-based poll. In the case of gathering information about a person indirectly, the information gathered must be quantified. This process is a process of reducing each aspect to a number in some manner.

After the person's profile, meaning such as that person's preferences, desires and characteristics, is determined in a quantitative manner the person's profile may be represented as a point in a defined multidimensional space. The back-end proximity engine is then able to calculate distance between points, which represents differences in such as preferences and behavior between person's profiles. Since every person is represented by a point, then each point represents a person's profile, thus it is possible to provide a list of persons most closely affiliated and/or far apart in profile. It is also then possible to measure a distance between any two persons, so we can say how much alike or apart they are in relation to the questions asked or other representative data provided by them or about them or on their behalf by a third party or service.

There are many uses for such information, such as grouping persons in social networks, and adding (or subtracting) by one person, other persons in one's social network. A multitude of all possible quantified values of a person's attributes (for example a multitude of person's responses to certain questions) could be viewed in multidimensional space. In a simple example such a space may be defined by a quantitative scale along each of several axes (in a Cartesian sense), relating to the nature of the question. For example, a female user might be asked: “On a scale of 1-100 describe your fondness for tall men, 1 being no attraction at all, and 100 being a very strong attraction. The answer to one such question becomes a locus (a point) in the space relative to the one axis. Another question, with quantified answers, defines a second axis. A third answer defines a third axis, and so on. The system may be planar (two axes), if there are two responses. It may be three-dimensional (three orthogonal axes in Cartesian coordinates) if there are three queries, or multidimensional if more than three. In any case, given a quantity for each defined axis, the dimensions define a point in the defined space. Of course the representation might be by angle and radius from a point, as well, or some other plotting system. Also in any case there is a well-known mathematical solution to determine the distance in the defined space between any two defined points in the space. So a plurality of persons may be represented in the defined space by sets of values of his or her attributes, such as answers to questions. The rank of the space is equal to the total quantity of attributes (questions in one embodiment) in the system database. The task of finding the nearest users therefore is equal to the task of finding the nearest points in multidimensional space (which is k-Nearest Neighborhood search query in DBMS terminology). In the simple case Huffman distance may be used as a space metric. In one embodiment of the invention the distance between two users is equal to the total number of all questions they answered differently. Every question both users answered differently is increases the distance by 1. However, the system described in this invention can use any other metric to measure the distance between users. For example for each of attributes its own metric could be defined.

In one case the distance between users might be calculated as a sum of distances between values of corresponding attributes of these users. For numeric attributes distance between values “x” and “y” can be calculated as an absolute value of the subtraction of the normalized value of “x” from the normalized value of “y”. Normalization could be used for transforming values to one common range (for example [0; 1]) for different attributes. Different axes may have different weight (the normalization factors). Change of weight allows allocating such attributes (for example questions) which values are more important for measurement of affinity between users than values of other attributes.

Moreover, for each group of attributes, more complicated metrics may be defined. For example one might use a classical Euclid metric for such a pair of attributes, which has a point associated with it in the two-dimensional sub-space from the common space of the Data Base. One could also add new synthetic attributes by calculating them using other attributes. For example, such attributes could be syntactical user characteristics calculated on the basis of some sociological model applied to the users' answers. In which case the answers used for calculation of such an attribute could remain or could be deleted from the space depending on how one might like distance to be calculated or particular task to be achieved.

### Front End

In one embodiment of the invention the front end may be a web server or other client interface in which a person can choose an answer or provide an answer to questions in a poll. In other embodiments it is possible to imagine a front end which is registering other personal related data, such as for example car or music preference.

Another function of a front end is to provide a graphical interpretation of a calculation received from the back-end. Such as for example lists of other persons and their proximity (distance) factors. For example the list of the five nearest users by their poll answer or the list of top five persons with attributes opposite. The front-end interacts with a data base where related polls or other data is stored, and with a proximity engine which may be used to calculate distance between person's points.

### Database

In one embodiment of the invention the database stores the following information: user accounts, questions and answers (in case of a poll) and all user answers provided to these questions over a period of time. In this embodiment the database is not used for proximity calculation due to relational database limitations in performing needed calculations. It is only used for storing the information and interaction with the back-end

### Back End

In many embodiments the back end includes the proximity engine. The proximity engine receives user requests (through the front end) and performs calculations for distance determination (proximity measurement).

The proximity engine performs, among others tasks in some embodiments, the following functions:
Add user's answer
Delete user's answer
Calculate the distance between two users (distance in the metric space, typically based on the number of matching or mismatching answers)
Calculate the nearest users (those who are closest to one another)
Calculate the farthest users (those who are farthest apart)

By interacting with the back end through the front end (for example web server+PHP) a person using the system can then review the results of the proximity calculations.

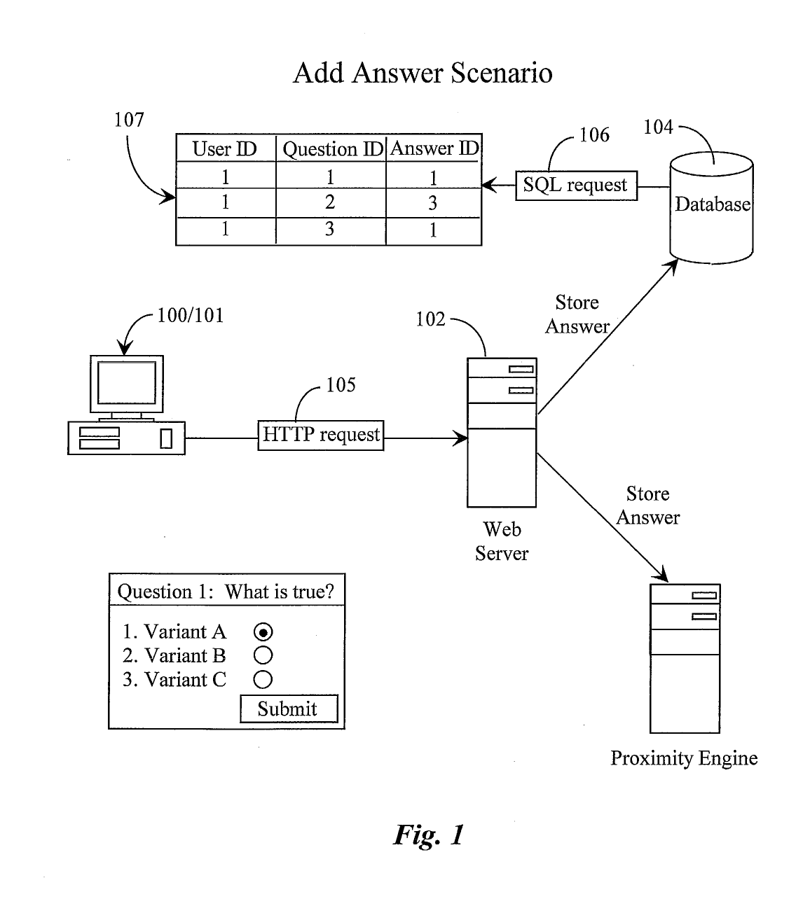

FIG. 1 is a diagram illustrating a system in one embodiment of the present invention, and operation for determining person's preferences. In this case a person 100 using a PC 101 having an installed internet browser or other similar client application sends a HTTP request 105 to a web server 102 in which there is user ID information (profile) as well as answers to questions 108 which are displayed on a web page. The web server executes script which in turn sends requests to a database server 104, which stores the answers provided by the user into a table 107 in a form of SQL request 106, and also sends the answers given to a proximity engine 103, which also stores all answers in its own memory for further use.

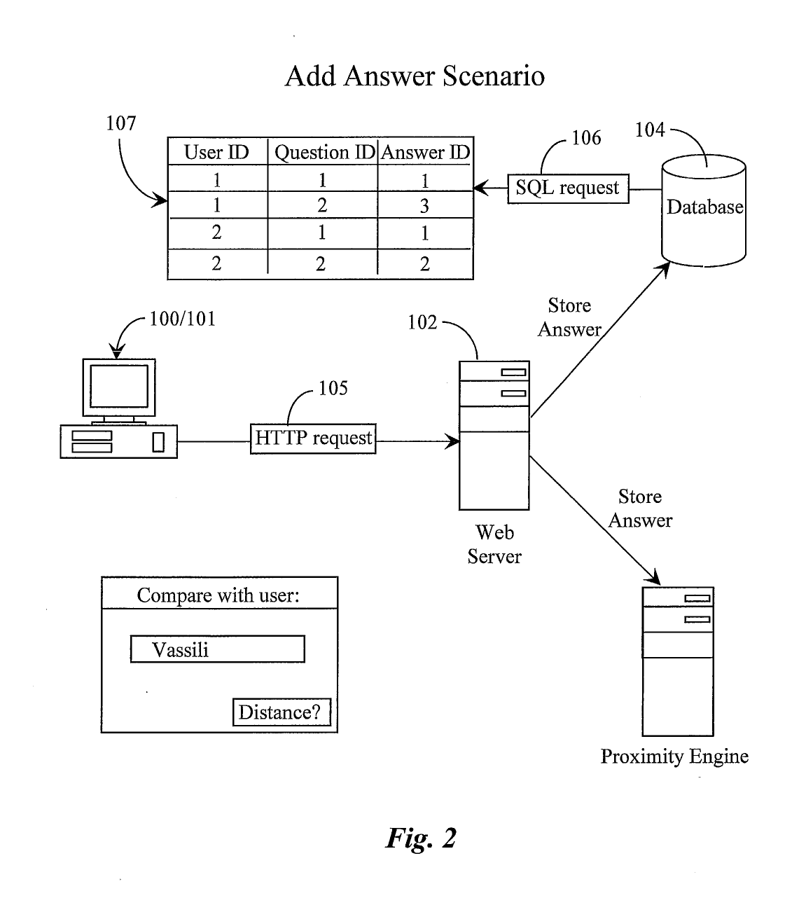

FIG. 2 is a diagram illustrating operation determining distance between two persons. Person 100 using a PC 101 with an installed internet browser or other client application sends an HTTP request 105 to web server 102 in which there is user ID information and at least one username of another user displayed on a web page 108. The web server executes script which sends the request to the proximity engine 103 to perform a distance calculation. The proximity Engine 103 compares user answers with answers of another user whose name is listed on the web page, Vassili in this example, and returns the number of matched or mismatched answers.

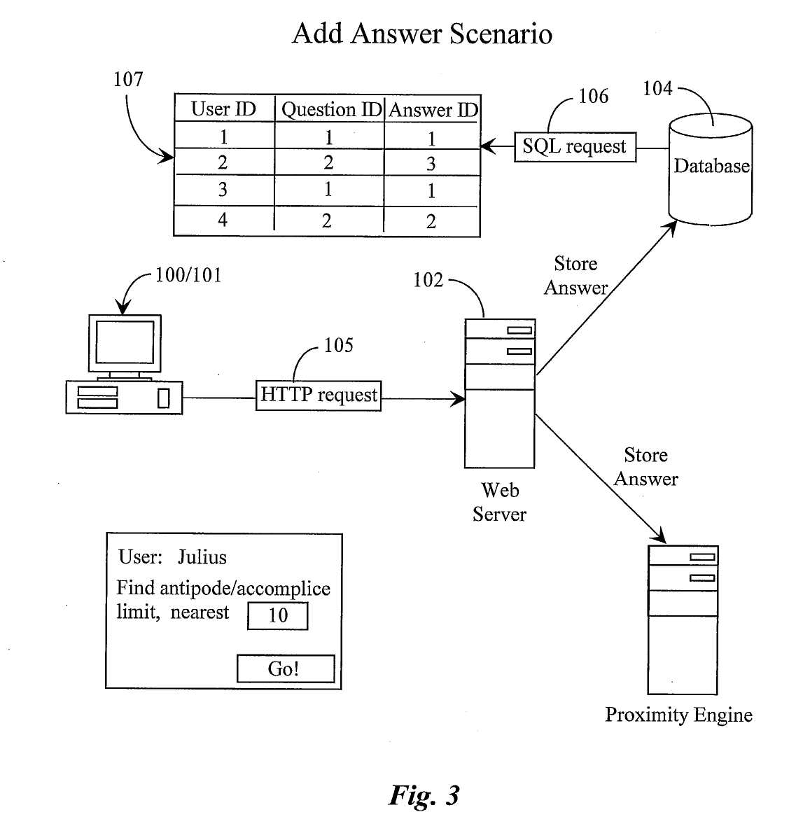

FIG. 3 is a diagram illustrating operation for determining nearest and farthest persons. Person 100 using PC 101 with an installed internet browser or other client application sends an HTTP request 105 to web server 102 in which there is a user ID and a preset limit for search of nearest users on a web page (108). The web server executes script which sends the request to proximity engine 103 to perform a search. Proximity Engine 103 compares answers for the one person with answers of other persons in the system, and provides a list of nearest and farthest persons, according to the predefined defined limits.

In yet another embodiment of the invention a person answers a predefined set of questions (test) and the person's answers are stored on the web site. The user then is assigned an ID which is stored in a cookie. He then could receive a button (an image with a URL in which his ID is encoded). This button then serves as user identity. The user, when seeing such an identity image of another user, may click on that button and be redirected to a web page which would provide instantly a distance calculation between the two persons.

In yet another embodiment of the invention an employer might create a set of questions and make the questions publicly available on a web site. The “right” or “ideal” answers to all of the questions might be kept secret in the database. Persons applying for employment might answer these question (possibly anonymously). At any given time, the employer could receive a list of persons which most closely gave the right answers and thus would be able to contact only the most relevant persons to consider for the job. The same system works the other way around where the employees could find a employer most closely following his or her values.

In still another embodiment of the invention a person's behavior may be predicted by analyzing the behavior of users in a close proximity. For example an election prediction system may be implemented where a known behavior (such as a candidate's political platform) may be taken as a reference point for comparison with any person, determining a proximity between the person and the candidate's behavior, thus determining a given person's political preference. Moreover persons do not necessarily need to answer questions related to political platform of a candidate, as long as there is cross-behavior between them. Moreover the referenced behavior can be taken from other persons in a close proximity to a referenced candidate. In this case, if most persons in closest proximity to another are, for example, democrats, the system can predict the given user (Democratic) behavior (i.e. his tendency towards Democrats). I.e. users can be mapped towards political candidates (in given example) without actually directly answering any “political” questions.

To make it really simple—if most democrats like to drive Toyota Prius cars we can assume that a user with strong preference to Toyota Prius cars is also a Democrat. Of course the predictions accuracy grows as more behavior patterns are collected.

Several examples have been described for the invention, but it is clear there may be variations in the limitations described in these examples without departing from the spirit and scope of the invention. For example, there are a number of ways persons may be tested for preferences and attributes other than the specific ways described in the examples. Polls might be conducted through interactive voice response over telephony systems, for example, instead of by having a person select answers in a list of answers on a web page. Further, there are a number of different ways that proximity may be determined, depending on the sort of multi-dimensional representation that might be used. The invention therefore is to be limited only by the claims that follow.

What is claimed is:

1. A method for comparing preferences of persons, comprising the steps of:
(a) determining a plurality of preferential characteristics of a first person, quantifying each of the plurality of characteristics of the first person, and expressing each quantified characteristic in a separate dimension of a multi-dimensional space having a number of dimensions equal to the number of characteristics to be represented, providing thereby a first point in the multidimensional space;
(b) determining a plurality preferential characteristics of a second person, quantifying each of the plurality of characteristics of the second person, and expressing each quantified characteristic in a separate dimension of a multi-dimensional space having a number of dimensions equal to the number of characteristics, providing thereby a second point in the multidimensional space; and
(c) calculating distance in the multidimensional space between the first and the second point, thereby providing an indication of the nearness of preference between the two persons.

2. The method of claim 1 wherein determining in steps (a) and (b) is accomplished by soliciting from persons answers to questions.

3. The method of claim 2 wherein in steps (a) and (b) quantifying is accomplished by framing questions to elicit quantitative responses.

4. The method of claim 1 wherein the space is Cartesian, the dimensions are separate axes all originating from a common point, and each of the plurality of characteristics is rendered as a numerical value plotted on the appropriate axis.

5. A system for comparing preferences of persons, comprising
a first mechanism gathering preferences of persons;
a second mechanism for rendering each preference as a numerical value;
a third mechanism for plotting each numerical value representing a preference for a person in a separate dimension of multi-dimensional space, providing for each person a point in the multi-dimensional space; and
a fourth mechanism for determining distance in multidimensional space between any two points representing different persons, and for storing the distances calculated in a data repository.

6. The system of claim 5 further comprising a fifth mechanism for interpreting the distance determined between two points as a difference in personal preference between the persons whose preferences are represented by the points.

7. The system of claim 5 wherein the first mechanism gathers by soliciting from persons answers to questions.

8. The system of claim 5 wherein in steps (a) and (b) quantifying is accomplished by framing questions to elicit quantitative responses.

9. The system of claim 5 wherein the multi-dimensional space is Cartesian, the dimensions are separate axes originating from a common point, and each of the plurality of characteristics is rendered as a numerical value plotted on the appropriate axis.

10. The system of claim 5 further comprising a fifth mechanism allowing one person to retrieve distances from the data repository as information for guiding decisions.

11. A method for predicting characteristics of persons, comprising steps of:
(a) determining a plurality of preferential characteristics for each of a plurality of persons, quantifying each of the plurality of characteristics for each person, and expressing each quantified characteristic in a separate dimension of a multi-dimensional space having a number of dimensions equal to the number of characteristics to be represented, providing thereby a point in the multidimensional space representing characteristics of each person;
(b) calculating distance in the multidimensional space between individual ones of the points, and using the calculated distances to predict one or more characteristics for at least one person other than those characteristics plotted for that one person in the multi-dimensional space.

12. The method of claim 11 wherein a first characteristic is known for one person other than characteristics plotted for that person in the multi-dimensional space, and the first characteristic is then assumed for other persons whose points in the multi-dimensional space lie within a pre-selected distance from the point for the one person.
